(19) United States
(12) Patent Application Publication
(10) Pub. No.: US 2016/0259113 A1
(43) Pub. Date: Sep. 8, 2016

(54) ILLUMINATING DEVICE, DISPLAY DEVICE, AND MOBILE ELECTRONIC APPARATUS

(71) Applicant: Seiko Epson Corporation, Tokyo (JP)

(72) Inventors: Hidekazu Kobayashi, Hara-mura (JP); Masatoshi Yonekubo, Hara-mura (JP)

(21) Appl. No.: 15/048,079

(22) Filed: Feb. 19, 2016

(30) Foreign Application Priority Data
Mar. 6, 2015 (JP) 2015-044367

(51) Int. Cl. F21V 8/00

(52) U.S. Cl. CPC G02B 6/0045; G02B 6/0073

(57) ABSTRACT

An illuminating device includes a first light-emitting element formed of a light-emitting diode and a light-guide plate having on a side surface thereof a first light-incident portion opposing the first light-emitting element. The light-guide plate in plan view has a shape having a curved surface on the side surface thereof at a distance from the first light incident portion. A plurality of first bevels facing the first light-incident portion at a certain angle exceeding (90°—critical angle) with respect to a virtual line extending from a center of the first light-incident portion are provided in at least part of an area of the curved surface in a circumferential direction.

### BACKGROUND

1. Technical Field

The present invention relates to an illuminating device provided with a light-guide plate and a light-emitting element, a display device, and a mobile electronic apparatus.

2. Related Art

In a display device provided with a reflective display panel, an illuminating device referred to as a so-called front light is used because transmitted light is not able to be used. The illuminating device described above allows light to enter from a side surface of the light-guide plate and emit illumination light from a surface of the light-guide plate on one side in a thickness direction toward the display panel. In the display device used in a mobile electronic apparatus, a light-emitting element such as a light-emitting diode is used as a light source. In such a case, an image display area of the display panel needs to be illuminated uniformly with a small number of the light-emitting elements from a viewpoint of power saving or the like.

JP-A-2013-88501 is an example of the related art.

As illustrated in FIG. 7, however, in the case where a light-guide plate 50 is provided with a curved surface 540 at a distance from light-incident portions 55 opposing light-emitting elements 40 on a side surface 54, there is a problem that illumination light emitted from an area (an area 50a indicated by a double-dashed chain line) of the light-guide plate 50 at a distance from the light-incident portions 55 has an extremely high intensity compared with an intensity of light emitted from other areas. Such intensity variations are not preferable because image quality is reduced. As a result of investigating causes of the problem described above, an inventor of this application found that light enters the light-guide plate 50 from the light-incident portions 55, partly enters the curved surface 540 at angles larger than a critical angle as indicated by light beams L, and is totally reflected and converged toward the area 50a.

### SUMMARY

An advantage of some aspects of the invention is to provide an illuminating device configured to reduce intensity variations of illumination light emitted from a light-guide plate even in a case where a curved surface is provided on a side surface of the light-guide plate, a display device including the illuminating device, and a mobile electronic apparatus including such a display device.

An illuminating device according to an aspect of the invention includes a first light-emitting element; and a light-guide plate including on a side surface a first light-incident portion opposing the first light-emitting element and configured to emit illumination light from a surface on one side in a thickness direction, in which the light-guide plate in plan view has a curved surface on the side surface thereof at a distance from the first light-incident portion, and a plurality of first bevels facing the first light-incident portion at a certain angle exceeding (90°—critical angle) with respect to a virtual line extending from a center of the first light-incident portion are formed in at least part of an area of the curved surface in a circumferential direction in plan view.

In the aspect, the plan view of the light-guide plate represents a shape of the light-guide plate when viewed from a direction perpendicular to a first surface.

In the aspect, although a curved surface is provided on the side surface of the light-guide plate, the plurality of first bevels facing the first light-incident portion at the certain angle exceeding (90°—critical angle) with respect to the corresponding virtual line extending from the center of the first light-incident portion are formed in at least part of the area of the curved surface in the circumferential direction in plan view. Therefore, light travelling linearly from the center of the first light-incident portion toward an area where the first bevels are provided is partly transmitted through the first bevels. Even though the rest of the light is reflected by the first bevels, such light is less likely to converge on a specific area inside the light-guide plate. In particular, since the plurality of first bevels each form a certain angle with respect to the corresponding virtual line, a direction in which the light reflected from the first bevel travels can be easily determined. Therefore, since intersection of the light reflected from the first bevels inside the light-guide plate can be easily avoided, concentration of the light reflected from the first bevels on a specific area inside the light-guide plate is reliably suppressed. Therefore, the occurrence of an event in which the illumination light exits from a specific area on one surface of the light-guide plate at an extremely high light intensity is reliably suppressed, and thus intensity variations of the illumination light are alleviated.

Preferably, the plurality of first bevels are each at a right angle with respect to the corresponding virtual line. In other words, preferably, the plurality of first bevels each form an angle of 90° with respect to the corresponding virtual line. In this configuration, when light travels linearly toward an area where the first bevels are formed, some of the light is reliably transmitted through the first bevels irrespective of the position of the first light-incident portion from which light travels. The light reflected from the first bevels travels toward the first light-incident portion, and thus the occurrence of an event in which the reflected light concentrates at a specific area inside the light-guide plate is reliably suppressed. Therefore, the illumination light that exits from one surface of the light-guide plate is reliably prevented from having an extremely high intensity in a specific area, and thus intensity variations of the illumination light are reliably alleviated.

Preferably, among the plurality of first bevels, end portions of the first bevels adjacent to each other in the circumferential direction are connected via a linear portion parallel to the virtual line. In this configuration, the first bevels can be easily designed. In addition, even when light travels linearly from the first light-incident portion toward points between the first bevels, the light is less likely to be reflected from the points between the first bevels.

Preferably, in plan view, all of the plurality of first bevels have the same length. In this configuration, the first bevels can be easily designed.

In the aspect, the illuminating device may have a configuration including a second light-emitting element, in which the light-guide plate includes a second light-incident portion opposing the second light-emitting element at a distance from the first light-incident portion on the side surface thereof, and includes a plurality of second bevels in at least part of the curved surface in a circumferential direction in plan view, and the second bevels each form a certain angle exceeding (90°—critical angle) with respect to a virtual line extending from a center of the second light-incident portion and face the second light-incident portion. In this configuration, light entering from the second light-incident portion is less likely to concentrate on a specific area of the light-guide plate. Therefore, the occurrence of an event in which the illumination light exits at an extremely high intensity from a specific area on one surface of the light-guide plate is avoided, and thus intensity variations of the illumination light are reliably alleviated.

Preferably, the light-emitting element is a light-emitting diode.

A display device provided with the illuminating device of the invention includes a display panel opposing the one surface of the light-guide plate.

In this case, a mode in which the display panel is a reflective display panel may be employed.

The display device of the invention may be used in various electronic apparatuses such as mobile electronic apparatuses.

### BRIEF DESCRIPTION OF THE DRAWINGS

The invention will be described with reference to accompanying drawings, wherein like numbers reference like elements.

FIGS. 1A and 1B are explanatory drawings illustrating a mode of a display device according to a first embodiment of the invention.

FIGS. 2A to 2C are explanatory views illustrating a plan view of a light-guide plate used in an illuminating device and the display device according to the first embodiment of the invention.

FIGS. 3A and 3B are explanatory drawings illustrating an intensity distribution of illumination light emitted from the illuminating device of the first embodiment of the invention.

FIGS. 4A to 4C are explanatory drawings illustrating a light-guide plate used in an illuminating device of a comparative example of the invention.

FIGS. 5A to 5C are explanatory drawings illustrating a light-guide plate used in an illuminating device and a display device according to a second embodiment of the invention.

FIG. 6 is an explanatory drawing illustrating a mobile electronic apparatus provided with the display device of the invention.

FIG. 7 is an explanatory drawing of a light-guide plate according to a reference example of the invention.

### DESCRIPTION OF EXEMPLARY EMBODIMENTS

Embodiments of the invention will be described with reference to the drawings. In the drawing referred to in the following description, layers and members are not drawn in actual sizes so that the layers and members are large enough to be recognizable in the drawings. In the following descriptions, the term “plan view of a light-guide plate 50” means a shape of the light-guide plate 50 when viewed from a right angle with respect to a first surface 51 of the light-guide plate 50.

### First Embodiment

### Configuration of Display Device

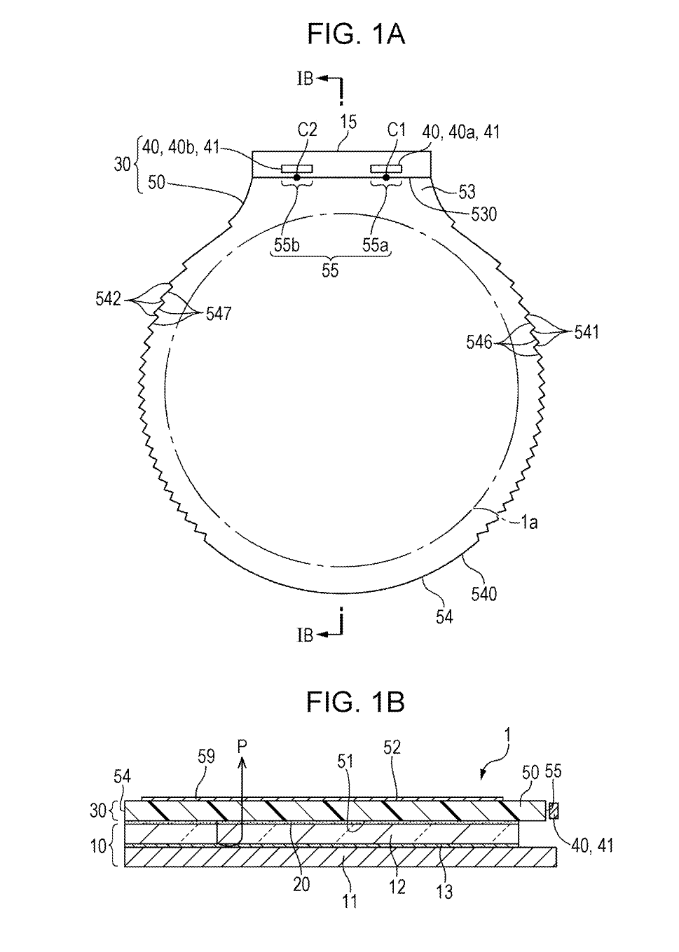

FIGS. 1A and 1B are explanatory drawings illustrating a mode of a display device according to a first embodiment of the invention. FIG. 1A is a plan view of the display device, and FIG. 1B is a cross-sectional view of the display device taken along line IB-IB.

A display device 1 illustrated in FIGS. 1A and 1B includes a display panel 10 and an illuminating device 30 having a light-guide plate 50 arranged so as to oppose the display panel 10.

In the first embodiment, the display panel 10 is a reflective display panel such as an electrophoretic panel, a reflective liquid-crystal panel, a MEMS device, or a light interference device and includes a first substrate 11, a light-transmissive second substrate 12 arranged so as to oppose the first substrate 11, and a display layer 13 provided between the first substrate 11 and the second substrate 12. A surface of the first substrate 11 opposing the second substrate 12 and a surface of the second substrate 12 opposing the first substrate 11 are provided with electrodes (not illustrated) configured to drive the display layer 13.

In the reflective display panel 10 described above, as illustrated by arrow P in FIG. 1B, illumination light entering from the second substrate 12 side is modulated by the display layer 13 while being reflected on the display layer 13 side and the first substrate 11 side and exits from the second substrate 12 side, so that an image is displayed. In this embodiment, the display panel 10 is an electrophoretic panel.

### Configuration of Illuminating Device 30

The illuminating device 30 is configured as a so-called front light and includes light-emitting elements 40 and a light-transmissive light-guide plate 50 having on a side surface 54 light-incident portions 55 opposing the light-emitting elements 40. In the first embodiment, the light-guide plate 50 is adhered to the second substrate 12 of the display panel 10 with a light-transmissive adhesive layer 20. The light-guide plate 50 is formed of a light-transmissive resin having a refractive index of 1.5 to 1.6, and in the first embodiment, the light-guide plate 50 is formed of a resin polycarbonate mold (refractive index=1.59).

In the illuminating device 30 as described above, light emitted from the light-emitting elements 40 enters the inside of the light-guide plate 50 from the light-incident portions 55 of the light-guide plate 50 and travels in the light-guide plate 50 while generating repeated reflections between a first surface 51 and a second surface 52 opposed in a thickness direction of the light-guide plate 50, and the illumination light is emitted toward the display panel 10 from the first surface 51 (one surface in the thickness direction), which is one of the first surface 51 and the second surface 52 and is located on the display panel 10 side. The illumination light is modulated by the display panel 10, enters the inside of the light-guide plate 50 from the first surface 51 of the light-guide plate 50, and then exits from the second surface 52, so that an image is displayed. In the first embodiment, at least one of the first surface 51 and the second surface 52 of the light-guide plate 50 has a light scattering portion 59 including projections and depressions at a predetermined distribution. In the first embodiment, the light scattering portion 59 includes a plurality of semi-spherical projections having, for example, a radius of 60 μm and a height of 10 μm and arranged at pitches of 0.2 mm on the second surface 52 of the light-guide plate 50. Only an area in which the light scattering portion 59 is formed is illustrated in FIG. 1B; illustration of projections which constitute some of the light scattering portion 59 is omitted.

In the first embodiment, the light-guide plate 50 has a substantially circular shape in plan view, and part of the light-guide plate 50 in the circumferential direction is a projecting portion 53 projecting radially outward. Therefore, substantially the entire part of the light-guide plate 50 in the circumferential direction except the projecting portion 53 has a curved surface 540 protruding radially outward. In the first embodiment, the light-guide plate 50 has a thickness of 0.4 mm and a diameter of 32 mm.

In the first embodiment, a distal end portion 530 of the projecting portion 53 has a linear shape, and the distal end portion 530 of the projecting portion 53 on the side surface 54 of the light-guide plate 50 has the light-incident portions 55. In the first embodiment, the light-incident portions 55 include a first light-incident portion 55a and a second light-incident portion 55b at positions adjacent to each other on the distal end portion 530 of the projecting portion 53. Therefore, the light-emitting elements 40 include a first light-emitting element 40a opposing the first light-incident portion 55a and a second light-emitting element 40b opposing the second light-incident portion 55b. In a width direction orthogonal to a direction in which the light-emitting elements 40 and the light-incident portions 55 oppose each other, the maximum width of the light-guide plate 50 is significantly larger than an area in which the light-incident portions 55 are provided.

The display panel 10 includes a substantially circular shape in plan view in the same manner as the light-guide plate 50 and includes a projecting portion 15 that overlaps the projecting portion 53 of the light-guide plate 50. However, the shape of the display panel 10 in plan view is not limited to the substantially circular shape and may be a rectangular shape. In any case, part of the area where the display panel 10 and the light-guide plate 50 overlap each other is used as an image display area 1a. In the first embodiment, the image display area 1a is configured as a circular area having a slightly smaller outer diameter than that of the light-guide plate 50.

In the first embodiment, the light-emitting elements 40 are, for example, light-emitting diodes 41 which emit white light. The light-emitting diodes 41 excite a yellow phosphor with blue light and generate white light. Therefore, the light-emitting elements 40 function as substantially oval-shaped surface light sources. The light-emitting elements 40 are arranged so that a short axis extends in the thickness direction of the light-guide plate 50 and a long axis extends in a direction of extension of the side surface 54 (the light-incident portions 55) of the light-guide plate 50.

### Detailed Configuration of Curved Surface 540 of Light-Guide Plate 50

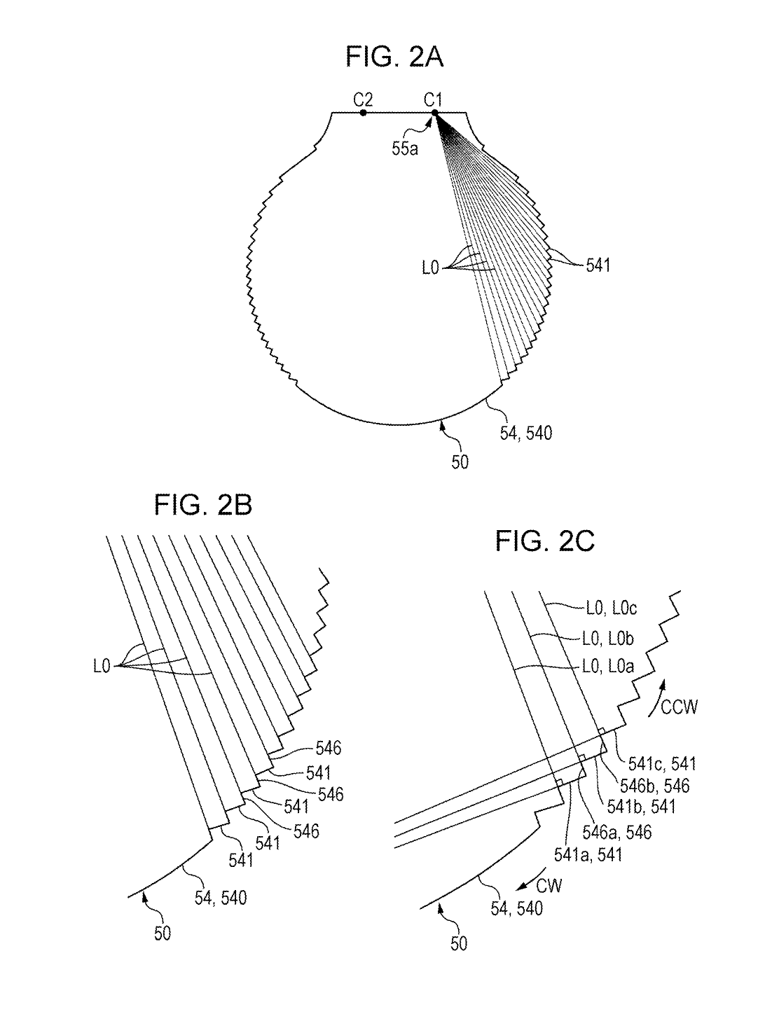

FIGS. 2A to 2C are explanatory views illustrating a plan view of the light-guide plate 50 used in the illuminating device 30 and the display device 1. FIGS. 2A, 2B, and 2C are an explanatory drawing for explaining virtual lines L0 extending linearly from the first light-incident portion 55a toward a part of an area of the curved surface 540, an explanatory drawing illustrating first bevels 541 provided in a part of the area of the curved surface 540 in an enlarged scale, and an explanatory drawing illustrating the first bevels 541 in a further enlarged scale, respectively.

As illustrated in FIGS. 1A and 1B and FIGS. 2A to 2C, the light-guide plate 50 of the illuminating device 30 of the first embodiment is provided with a plurality of first bevels 541 facing a center C1 of the first light-incident portion 55a and formed continuously in at least part of the curved surface 540 in the circumferential direction. In the first embodiment, the curved surface 540 of the light-guide plate 50 is provided with the first bevels 541 in an area where the first light-incident portion 55a is located in the widthwise direction. The light-guide plate 50 is also provided with a plurality of second bevels 542 facing a center C2 of the second light-incident portion 55b and formed continuously in at least part of the curved surface 540 in the circumferential direction. In the first embodiment, the second bevels 542 are provided on the side where the second light-incident portion 55b is located in the widthwise direction of the curved surface 540 of the light-guide plate 50.

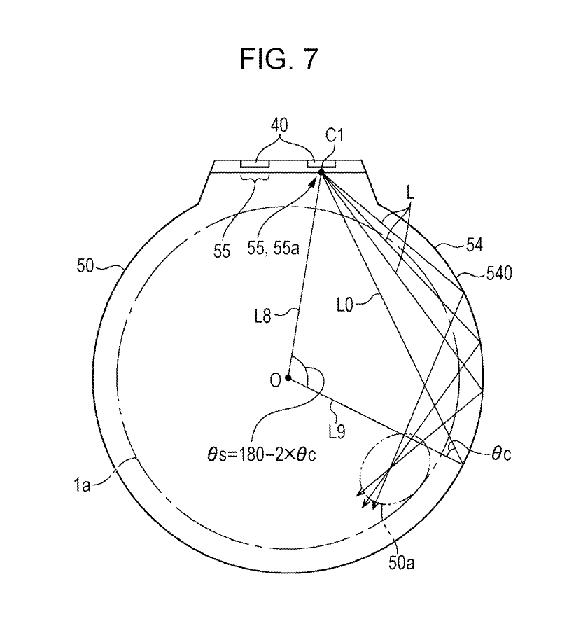

In the first embodiment, the area where the plurality of first bevels 541 are formed corresponds to an area in which part of light that has entered the light-guide plate 50 from the first light-incident portion 55a enters at an angle larger than a critical angle with respect to the curved surface 540 of the light-guide plate 50 illustrated in FIG. 7 in plan view.

When setting the area as described above, first, the center C1 of the first light-incident portion 55a is assumed to be positioned on an exact circle which constitutes part of the curved surface 540 as illustrated in FIG. 7. Then, when θc is defined as a critical angle of light entering the curved surface 540 from the center C1 of the first light-incident portion 55a, an angular range in which an angle θs formed between an auxiliary line L8 connecting the center C1 of the first light-incident portion 55a and an arc center O of the curved surface 540 and an auxiliary line L9 connecting a position on the curved surface 540 and the arc center O becomes smaller than (180°—2×critical angle θc) is determined as a totally reflecting range. The totally reflecting range described above is an area where total reflection occurs in the curved surface 540 when light travelling from the first light-incident portion 55a reaches the curved surface 540.

Therefore, in the first embodiment, the first bevels 541 illustrated in FIGS. 1A and 1B are formed in the totally reflecting range (angular range) in which the angle θs formed between the above-described auxiliary lines L8 and L9 becomes smaller than (180°—2×critical angle θc). For example, in the first embodiment, the critical angle θc is 39° since the refractive index of polycarbonate which constitutes the light-guide plate 50 is 1.59. Therefore, in the first embodiment, the plurality of first bevels 541 are formed over an angular range of 102° in which the angle θs formed between the above-descried auxiliary lines L8 and L9 becomes smaller than (180°—2×39°).

In plan view of the light-guide plate 50, all of the plurality of first bevels 541 illustrated in FIGS. 1A and 1B and FIGS. 2A to 2C face the center C1 at a certain angle exceeding (90°—critical angle θc) with respect to the virtual lines L0 extending from the center C1 of the first light-incident portion 55a. In the first embodiment, since the critical angle θc is 39°, all of the plurality of first bevels 541 illustrated in FIGS. 1A and 1B and FIGS. 2A to 2C face the center C1 at a certain angle exceeding 51° with respect to the virtual lines L0 extending from the center C1 of the first light-incident portion 55a. Therefore, light travelling linearly from the center C1 of the first light-incident portion 55a is not totally reflected in any of the plurality of first bevels 541.

As illustrated in FIG. 2B, in the first embodiment, all of the plurality of first bevels 541 face the center C1 at an angle of 90° with respect to the virtual lines L0 extending from the center C1 of the first light-incident portion 55a. Therefore, in any of the plurality of first bevels 541, not only light travelling linearly from the center C1 of the first light-incident portion 55a but also light travelling linearly from any positions in the first light-incident portion 55a do not reflect totally.

In the first embodiment, all of the plurality of first bevels 541 have the same length, and in the first embodiment, all of the plurality of first bevels 541 have, for example, a predetermined dimension. Among the plurality of first bevels 541, end portions of the first bevels 541 adjacent to each other in the circumferential direction are connected via linear portions 546 parallel to the virtual lines L0.

In order to set the first bevels 541 as described above, first, a first bevel 541a having a predetermined dimension which forms an angle of 90° with respect to a virtual line L0a is set as illustrated in FIG. 2C. At this time, an end portion of the first bevel 541a on one side CW in the circumferential direction is set on the virtual line L0a. Subsequently, a linear portion 546a is provided along a virtual line L0b passing through an end portion on the other side CCW in the circumferential direction of the first bevel 541a. Subsequently, a first bevel 541b having a predetermined dimension which forms an angle of 90° with respect to the virtual line L0b from a distal end portion of the linear portion 546a as a starting point. Subsequently, a linear portion 546b is provided along a virtual line L0c passing through the end portion on the other side CCW in the circumferential direction of the first bevel 541b. Subsequently, a first bevel 541c having a predetermined length which forms an angle of 90° with respect to the virtual line L0c from a distal end portion of the linear portion 546b as a starting point. By repeating such an operation, the plurality of first bevels 541 are formed continuously with respect to the curved surface 540. At that time, the length of the first bevels 541 and the length of the linear portions 546 are set so that the first bevels 541 and the linear portions 546 are positioned within an area of 0.5 mm, for example, from a circumcircle of the curved surface 540. Since the light-guide plate 50 is a resin mold, the above-described setting is performed at the time of designing a die used for molding the light-guide plate 50.

The area in which second bevels 542 are formed illustrated in FIGS. 1A and 1B corresponds to an area where part of light entering the light-guide plate 50 from the second light-incident portion 55b enters at an angle larger than the critical angle with respect to the curved surface 540 and totally reflects toward a specific area in the same manner as the area where the first bevels 541 are formed. The plurality of second bevels 542 will not be described in detail because they have the same configuration as the first bevels 541. The second bevels 542 face the second light-incident portion 55b at a certain angle exceeding (90°—critical angle) with respect to virtual lines extending from the center C2 of the second light-incident portion 55b. The plurality of second bevels 542 form an angle of 90° with respect to the virtual lines extending from the center C2 of the second light-incident portion 55b. Among the plurality of second bevels 542, end portions of the second bevels 542 adjacent to each other in the circumferential direction are connected via linear portions 547 parallel to the virtual lines L0.

### Main Effects of First Embodiment

As described thus far, in the illuminating device 30 and the display device 1 of the first embodiment, although the curved surface 540 is provided on the side surface 54 of the light-guide plate 50, a plurality of first bevels 541 facing the first light-incident portion at a certain angle exceeding (90°—critical angle) with respect to a virtual line L0 extending from a center C1 of the first light-incident portion 55a are formed in at least part of an area of the curved surface 540 in a circumferential direction in plan view. Therefore, even if light travels linearly from the center C1 of the first light-incident portion 55a toward an area where the first bevels 541 are formed, the light is partly transmitted through the first bevels 541. Even though remaining parts of the light reflect from the first bevels 541, such parts of the light are less likely to converge on a specific area of the light-guide plate 50.

In particular, since the plurality of first bevels 541 each form a certain angle with respect to the corresponding virtual line L0, a direction in which light reflected from the first bevel 541 travels can be easily determined. Therefore, intersection of the light reflected from the first bevels 541 inside the light-guide plate 50 can be easily avoided. Therefore, the occurrence of an event in which concentration of the light reflected from the first bevels 541 on the specific area inside the light-guide plate 50 is reliably suppressed. Further, the plurality of first bevels 541 form a certain angle with respect to the virtual lines L0. Therefore, total reflection can advantageously be prevented even though the angles formed with respect to the virtual lines L0 are not set in accordance with the position in the circumferential direction for each of the first bevels 541. Specifically, in the first embodiment, the plurality of first bevels 541 form an angle of 90° with respect to the virtual lines L0. Therefore, irrespective of the position in the first light-incident portion 55a from which light travels linearly toward an area where the first bevels 541 are formed, part of light is reliably transmitted therethrough. In addition, since the plurality of first bevels 541 each form an angle of 90° with respect to the corresponding virtual line L0, the light reflected from the first bevels 541 travels toward the first light-incident portion 55a. Therefore, the occurrence of an event in which concentration of the light reflected from the first bevels 541 on the specific area inside the light-guide plate 50 is reliably suppressed.

In addition, the curved surface 540 of the light-guide plate 50 is provided with the second bevels 542, which are similar to the first bevels 541.

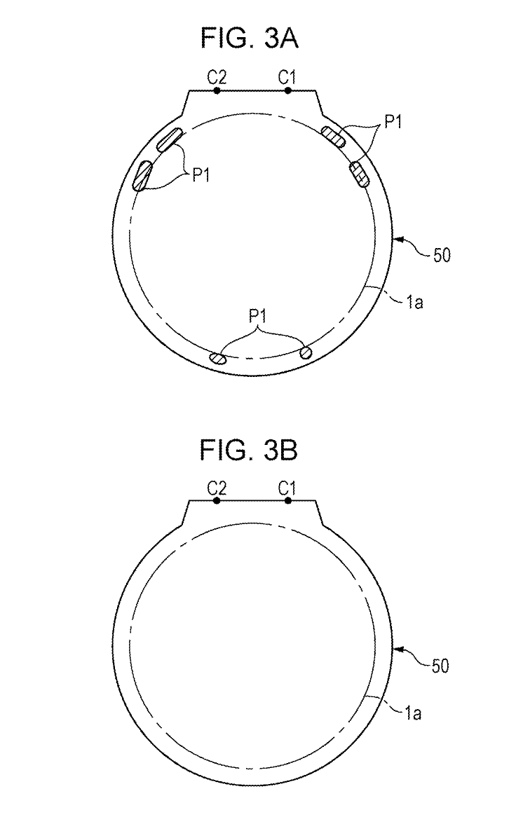

Therefore, as will be described later with reference to FIGS. 3A and 3B, the occurrence of an event in which the illumination light has an extremely high light intensity from a specific area on the first surface 51 (one surface) of the light-guide plate 50 is avoided, and thus intensity variations of the illumination light are alleviated.

Since the lengths of the plurality of first bevels 541 are the same, the first bevels 541 can be easily designed. Among the plurality of first bevels 541, the end portions of the first bevels 541 adjacent to each other in the circumferential direction are connected via linear portions 546 parallel to the virtual lines L0. Therefore, the first bevels 541 can be easily designed. In addition, even when light travels linearly from the first light-incident portion 551 to points between the first bevels 541, the light is less likely to be reflected from the points between the first bevels 541.

### Intensity Distribution of Illumination Light

FIGS. 3A and 3B are explanatory drawings illustrating intensity distribution of illumination light emitted from the illuminating device 30 according to the first embodiment of the invention. Areas having a relatively high intensity are indicated schematically by hatching on the basis of a result of simulation of the intensity distribution. FIGS. 3A and 3B illustrate intensity distribution in a case where the light-guide plate 50 is not provided with the light scattering portion 59, and intensity distribution in a case where the light-guide plate 50 is provided with the light scattering portion 59 in an optimal manner, respectively.

As illustrated in FIG. 3A, with illumination light emitted from the illuminating device 30 according to the first embodiment of the invention, only areas P1 having intensities which are relatively higher by a small extent (hatched areas) are partly generated even without providing the light scattering portion 59. Therefore, as illustrated in FIG. 3B, the areas having relatively higher intensities are not generated by arranging the light scattering portion 59 illustrated in FIG. 1B adequately, so that intensity variations are effectively alleviated.

### Comparative Example

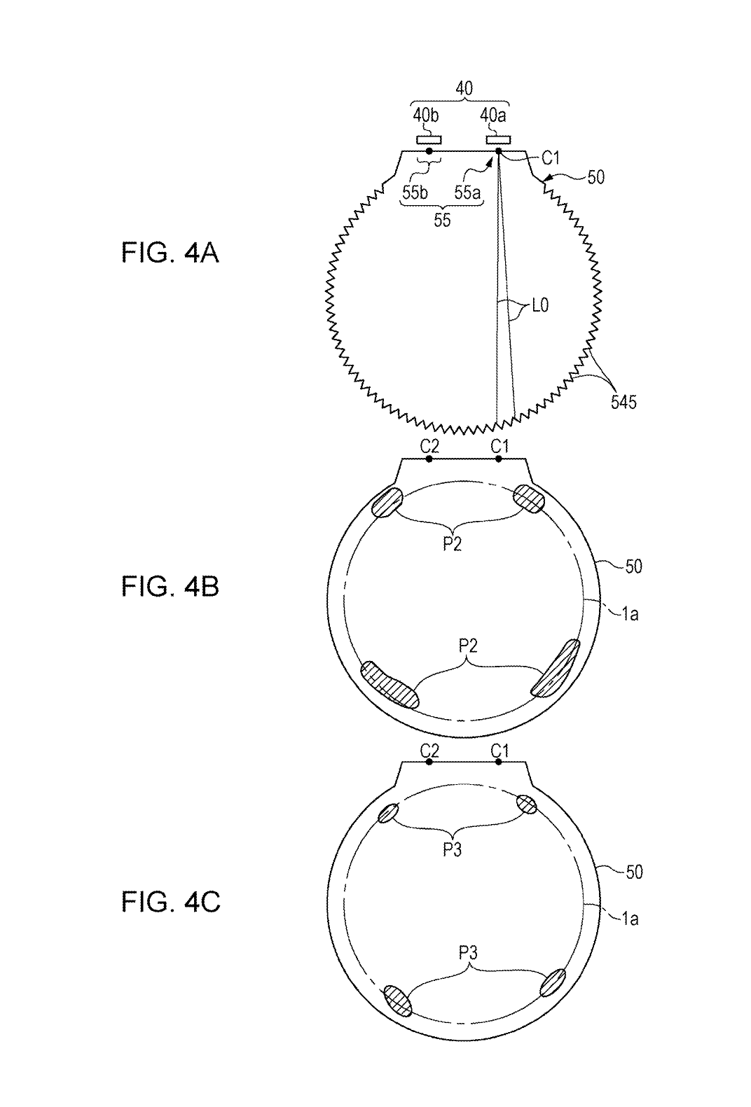

FIGS. 4A to 4C are explanatory drawings of the light-guide plate 50 used in the illuminating device according to a comparative example of the invention and are an explanatory plan view illustrating the light-guide plate 50, the intensity distribution in the case where the light scattering portion 59 is not provided on the light-guide plate 50, and the intensity distribution in the case where the light scattering portion 59 is provided adequately on the light-guide plate 50, respectively. In FIGS. 4B and 4C, areas having a relatively high intensity are schematically illustrated by hatched areas on the basis of a result of simulation of the intensity distribution. The basic configuration of this example is the same as the first embodiment, and thus the same parts are designated by the same reference numerals and the description of the same parts will be omitted.

The light-guide plate 50 illustrated in FIG. 4A is provided with a plurality of bevels 545 along the curved surface 540. The bevels 545 form the same angle with respect to a tangent line with respect to the curved surface 540. Therefore, angles of top portions of a plurality of triangles formed by the bevels 545 are the same and are, for example, 58.6°. In this configuration, angles formed at the plurality of bevels 545 with respect to the virtual lines L0 extending linearly from the center C1 of the first light-incident portion 55a are different. Therefore, a large number of the bevels 545 that form angles not larger than (90°—critical angle) with respect to the virtual lines L0 are included in the plurality of bevels 545, and total reflection occurs in these bevels 545.

Therefore, as illustrated in FIG. 4B, in the case where the light scattering portion 59 is not provided, areas P2 having relatively high intensities (hatched area) are generated. Therefore, as illustrated in FIG. 4C, areas P3 having relatively higher intensities are generated even by arranging the light scattering portion 59 illustrated in FIG. 1B adequately, so that it is difficult to effectively alleviate intensity variations.

### Second Embodiment

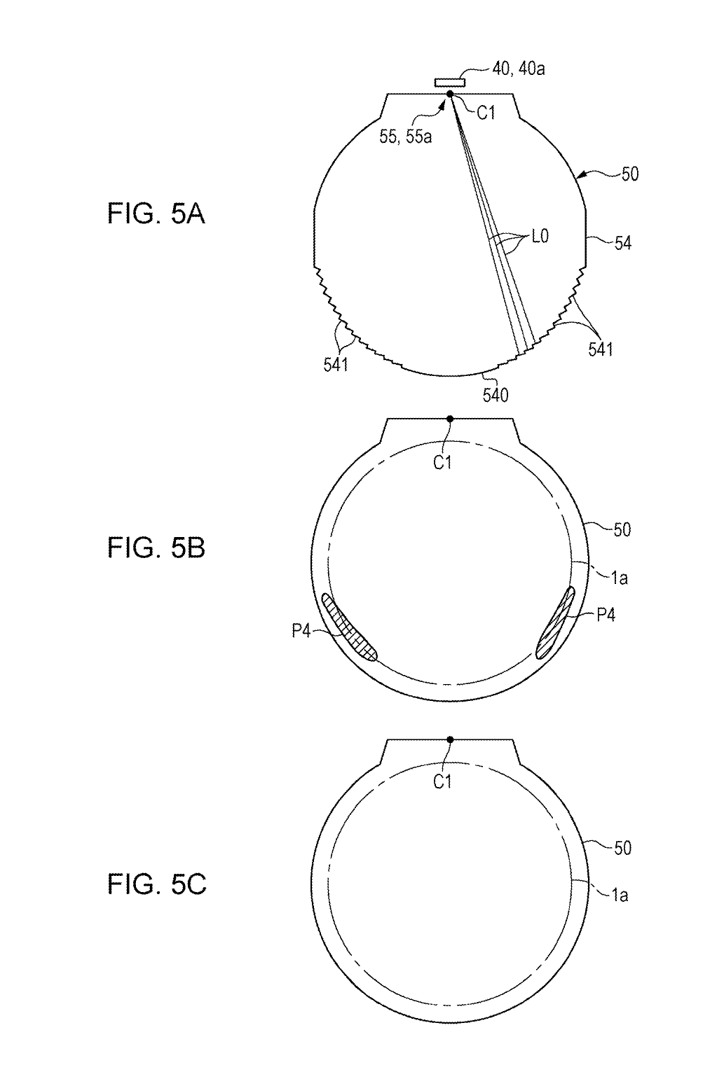

FIGS. 5A to 5C are explanatory drawings of the light-guide plate 50 used in the illuminating device 30 and the display device 1 according to a second embodiment of the invention and are an explanatory view illustrating a plan view of the light-guide plate 50, intensity distribution in the case where the light scattering portion 59 is not provided on the light-guide plate 50, and intensity distribution in the case where the light scattering portion 59 is provided adequately on the light-guide plate 50, respectively. In FIGS. 5B and 5C, areas having a relatively high intensity are schematically illustrated by hatched areas on the basis of the result of simulation of the intensity distribution. The basic configuration of the second embodiment is the same as the first embodiment, and thus the same parts are designated by the same reference numerals and the description of the same parts will be omitted.

The light-guide plate 50 illustrated in FIG. 5A is provided with only one of the light-emitting elements 40 which have been described in the first embodiment, and thus the light-guide plate 50 is provided only with a single light-incident portion 55. The light-emitting element 40 here corresponds to the first light-emitting element 40a of the first embodiment, and the light-incident portion 55 corresponds to the first light-incident portion 55a of the first embodiment.

In the same manner as the first embodiment, the light-guide plate 50 having the configuration described above is provided with the plurality of first bevels 541 facing a center C1 of the first light-incident portion 55a and formed continuously in at least part of the curved surface 540 in the circumferential direction. In the second embodiment, the first bevels 541 are formed on the curved surface 540 of the light-guide plate 50 on both sides with respect to the first light-incident portion 55a in the widthwise direction, and the first bevels 541 face the first light-incident portion 55a at a certain angle exceeding (90°—critical angle) with respect to the virtual lines L0 extending from the center C1 of the first light-incident portion 55a as described in conjunction with the first embodiment irrespective of the side where the first bevels 541 are arranged. In the second embodiment as well, in the same manner as the first embodiment, all of the plurality of first bevels 541 face the first light-incident portion 55a at an angle of 90° with respect to the virtual lines L0 extending from the center C1 of the first light-incident portion 55a. Therefore, in the second embodiment as well, in the same manner as the first embodiment, the occurrence of an event in which the illumination light has an extremely high light intensity from a specific area on the light-guide plate 50 is avoided, and thus intensity variations of the illumination light are alleviated.

For example, as illustrated in FIG. 5B, with illumination light emitted from the illuminating device 30 of the second embodiment, only areas P4 having intensities which are relatively higher by a small extent (hatched areas) are partly generated even without the light scattering portion 59. Therefore, as illustrated in FIG. 5C, the areas having relatively higher intensities are not generated by arranging the light scattering portion 59 illustrated in FIG. 1B adequately, so that intensity variations are effectively alleviated.

### Other Embodiments

In the embodiments described above, the lengths of the plurality of first inclined surfaces 541 are the same. However, a mode in which the lengths of the plurality of the first inclined surfaces 541 are different may be employed. In the embodiments described above, the angles formed between the virtual lines L0 adjacent each other are different. However, the angles formed between the virtual lines L0 adjacent to each other may be the same. In this case, the shorter the distance between the first inclined surfaces 541 and the light source C1 becomes, the shorter the length of the first inclined surfaces 541. In the above embodiments, the light-guide plate 50 has a substantially circular shape in plan view. However, the invention may be applied in the case where the light-guide plate 50 has an ellipsoidal shape or an oval shape. Furthermore, although the entire shape has a rectangular shape, the invention may be applied to the case where the light-guide plate 50 provided with the curved surface partly in the circumferential direction is used. In the above embodiments, since the display panel 10 is the reflective display panel, the illuminating device 30 is used as a front light. However, a configuration in which a light-transmissive display panel is used as the display panel 10 and the illuminating device 30 is used as a back light is also applicable. In addition, the illuminating device 30 of the invention may be used in photo frames configured to accommodate photos for exhibition, or in advertising displays, instrument used in automobiles or the like. Configuration Example of Mobile Electronic Apparatus

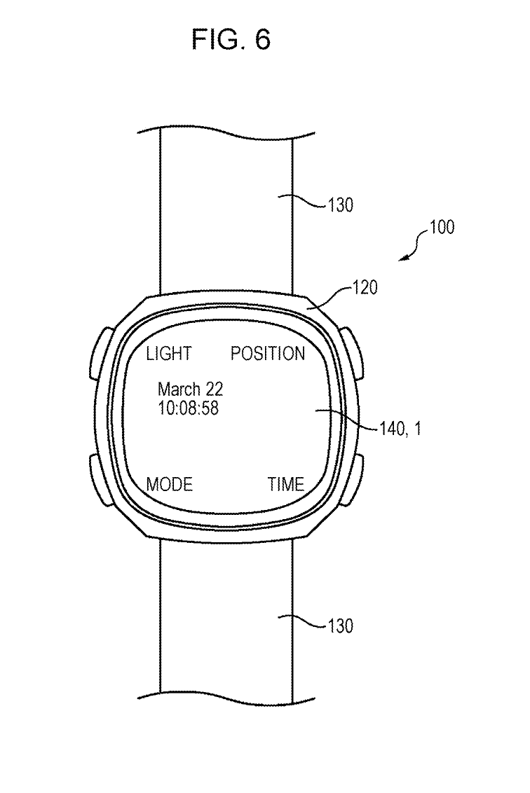

FIG. 6 is an explanatory drawing illustrating a mobile electronic apparatus 100 provided with the display device 1 of the invention. The mobile electronic apparatus 100 illustrated in FIG. 6 is a wrist-wearing electronic apparatus and includes a main body portion 120 and a band portion 130. The man body portion 120 includes function of a GPS (Global Positioning System) which is one of satellite measurement system integrated therein in addition to a function as a watch. A display portion 140 is provided at a center of the main body portion 120, and the display portion 140 includes the display device 1 described with reference to FIGS. 1A and 1B and so forth, whereby current day, time, and positional information are displayed.

The display device 1 of the invention may be used as display devices for mobile phones, Personal Digital Assistants, camera finders, or electronic papers in addition to the mobile electronic apparatus 100 illustrated in FIG. 6.

The entire disclosure of Japanese Patent Application No. 2015-044367, filed Mar. 6, 2015 is expressly incorporated by reference herein.

What is claimed is:

1. An illuminating device comprising:
a first light-emitting element; and
a light-guide plate including on a side surface thereof a first light-incident portion opposing the first light-emitting element, and configured to emit illumination light from a surface on one side in a thickness direction, wherein
the light-guide plate in plan view has a shape having a curved surface on the side surface thereof at a distance from the first light-incident portion, and
a plurality of first bevels facing the first light-incident portion at a certain angle exceeding (90°—critical angle) with respect to a virtual line extending from a center of the first light-incident portion are provided in at least part of an area of the curved surface in a circumferential direction in plan view.

2. The illuminating device according to claim 1, wherein
the plurality of first bevels each form an angle of 90° with respect to the corresponding virtual line.

3. The illuminating device according to claim 1, wherein
among the plurality of first bevels, end portions of the first bevels adjacent to each other in the circumferential direction are connected via a linear portion parallel to the virtual line in plan view.

4. The illuminating device according to claim 1, wherein
the plurality of first bevels have the same length in plan view.

5. The illuminating device according to claim 1, further comprising:
a second light-emitting element; wherein
the light-guide plate includes a second light-incident portion opposing the second light-emitting element at a distance from the first light-incident portion on the side surface thereof, and
a plurality of second bevels facing the second light-incident portion at a certain angle exceeding (90°—critical angle) with respect to a virtual line extending from a center of the second light-incident portion are provided in at least part of an area of the curved surface in a circumferential direction in plan view.

6. The illuminating device according to claim 1, wherein
the light-emitting element is a light-emitting diode.

7. A display device comprising:
the illuminating device according to claim 1 and
a display panel opposing the surface on one side of the light-guide plate.

8. A display device comprising:
the illuminating device according to claim 2 and
a display panel opposing the one surface of the light-guide plate.

9. A display device comprising:
the illuminating device according to claim 3 and
a display panel opposing the one surface of the light-guide plate.

10. A display device comprising:
the illuminating device according to claim 4 and
a display panel opposing the one surface of the light-guide plate.

11. A display device comprising:
the illuminating device according to claim 5 and
a display panel opposing the one surface of the light-guide plate.

12. A display device comprising:
the illuminating device according to claim 6 and
a display panel opposing the one surface of the light-guide plate.

13. The display device according to claim 7, wherein
the display panel is a reflective display panel.

14. A mobile electronic apparatus comprising:
the display device according to claim 7.

15. A mobile electronic apparatus comprising:
the display device according to claim 13.
